(19) United States
(12) Patent Application Publication
(10) Pub. No.: US 2022/0220407 A1
(43) Pub. Date: Jul. 14, 2022

(54) GRAPHENE COATING COMPOSITION FOR WIPER BLADE AND METHOD FOR COATING WIPER BLADE USING THE SAME

(71) Applicant: CAP CORPORATION, Sangju-si (KR)

(72) Inventors: Ki Young KIM, Sangju-si (KR); Jong Yuen KIM, Sangju-si (KR)

(21) Appl. No.: 17/647,497

(22) Filed: Jan. 10, 2022

(30) Foreign Application Priority Data
Jan. 11, 2021 (KR) 10-2021-0003333
Mar. 26, 2021 (KR) 10-2021-0039613

(51) Int. Cl. C10M 111/04; C10M 103/02; C10M 107/44; C10M 103/06; C10M 107/50; C10M 107/38; C10M 107/04; C10M 159/00; C10M 169/04; B60S 1/38

(52) U.S. Cl. CPC C10M 111/04; C10N 2050/015; C10M 107/44; C10M 103/06; C10M 107/50; C10M 107/38; C10M 107/04; C10M 159/00; C10M 169/042; B60S 1/38; C10M 2201/0413; C10M 2217/0453; C10M 2201/003; C10M 2229/025; C10M 2213/0623; C10M 2205/0225; C10M 103/02

(57) ABSTRACT

The present disclosure relates to a graphene coating composition for a wiper blade and a method for coating a wiper blade using the same. More particularly, the present disclosure relates to a graphene coating composition for a wiper blade that may improve durability and an abrasion resistance of the wiper blade, and a method for coating a wiper blade using the same.

### CROSS REFERENCE TO RELATED APPLICATION

This application claims the benefit of Korean Patent Application No. 10-2021-0003333, filed on Jan. 11, 2021, entitled “GRAPHENE COATING COMPOSITION FOR WIPER BLADE AND METHOD FOR COATING WIPER BLADE USING THE SAME”, which is hereby incorporated by reference in its entirety into this application.

### BACKGROUND

### 1. Field

The present disclosure relates to a graphene coating composition for a wiper blade and a method for coating a wiper blade using the same. More particularly, the present disclosure relates to a graphene coating composition for a wiper blade that may improve durability, an abrasion resistance, and a slip property of the wiper blade, and a method for coating a wiper blade using the same.

### 2. Description of Related Art

Wiper blades are in contact with a windshield of transportation equipment such as a vehicle, an aircraft, or a ship or industrial machinery such as construction machinery and play a role in wiping the windshield. The wiper blade is designed to operate at an angle of about 30° to 50° with the windshield.

Wiper blade rubber is mounted in a sliding portion of a wiper. For example, in a windshield wiper for a vehicle, rain, snow, dust, mud, and the like attached to a glass surface are removed by an operation of the wiper blade rubber as the wiper is driven.

However, in a case where the wiper blade has a high contact pressure, noise and abrasion of rubber occur, whereas in a case where the wiper blade has a low contact pressure, foreign substances cannot be properly wiped off, which may cause functional problems of the wiper blade.

Therefore, in order to prevent uneven abrasion of the wiper blade and to evenly wipe off the foreign substances, there is a demand for a wiper blade having improved wiping durability and abrasion resistance at the same time.

As a background art of the present disclosure, Japanese Patent No. 4,502,591 discloses a technique related to wiper blade rubber.

### SUMMARY

An object of the present disclosure is to provide a graphene coating composition for a wiper blade that may improve an abrasion resistance and durability of the wiper blade at the same time.

Another object of the present disclosure is to provide a graphene coating composition for a wiper blade that may improve a slip property and durability of the wiper blade.

Still another object of the present disclosure is to provide a wiper blade having an improved abrasion resistance, slip property, and durability at the same time using the graphene coating composition for a wiper blade of the present application.

Still another object of the present disclosure is to provide a method for coating a wiper blade capable of improving durability, an abrasion resistance, and a slip property of the wiper blade at the same time using the graphene coating composition for a wiper blade of the present application.

Other objects and advantages of the present disclosure will be more apparent by the following detailed description, the claims, and the drawings.

According to an aspect, there is provided a graphene coating composition for a wiper blade, containing, based on a total weight of the graphene coating composition for a wiper blade: 1 wt % to 16 wt % of a solid lubricant; 80 wt % to 90 wt % of an organic solvent; 2 wt % to 8 wt % of a binder; and 0.5 wt % to 3 wt % of an additive, wherein the solid lubricant contains graphene.

According to an embodiment, the binder may contain a polyurethane resin.

According to an embodiment, the solid lubricant may be contained in an amount of 6 wt % to 16 wt % based on the total weight of the graphene coating composition for a wiper blade.

According to an embodiment, the graphene may be contained in an amount of 10 wt % to 100 wt % based on a total weight of the solid lubricant.

According to an embodiment, the solid lubricant may further contain one or more selected from graphite and boron nitride.

According to an embodiment, the graphene may be contained in an amount of 10 wt % to 90 wt % based on a total weight of the solid lubricant, and the graphite may be contained in an amount of 10 wt % to 90 wt % based on the total weight of the solid lubricant.

According to an embodiment, the graphene may be contained in an amount of 20 wt % to 80 wt % based on a total weight of the solid lubricant, and the graphite may be contained in an amount of 20 wt % to 80 wt % based on the total weight of the solid lubricant.

According to an embodiment, the graphene may be contained in an amount of 40 wt % to 85 wt % based on a total weight of the solid lubricant, and the boron nitride may be contained in an amount of 15 wt % to 60 wt % based on the total weight of the solid lubricant.

According to an embodiment, the solid lubricant may further contain one or more selected from silicone powder, Teflon powder, PE powder, and a pigment.

According to an embodiment, the graphene may be contained in an amount of 70 wt % to 90 wt % based on a total weight of the solid lubricant, the one or more selected from graphite and boron nitride may be contained in an amount of 10 wt % to 30 wt % based on the total weight of the solid lubricant, and the one or more selected from silicone powder, Teflon powder, PE powder, and a pigment may be contained in an amount of 0 wt % to wt % based on the total weight of the graphene coating composition for a wiper blade.

According to an embodiment, the graphene may be contained in an amount of 70 wt % to 90 wt % based on the total weight of the solid lubricant, the graphite may be contained in an amount of 10 wt % to 30 wt % based on the total weight of the solid lubricant, and the Teflon powder may be contained in an amount of 0.1 wt % to 1 wt % based on the total weight of the graphene coating composition for a wiper blade.

According to an embodiment, the pigment may include a pearl pigment or an organic pigment.

According to an embodiment, a particle size of the pigment may be 9 μm to 40 μm.

According to an embodiment, the graphene coating composition may improve one or more of an abrasion resistance and a slip property of the wiper blade.

According to another aspect, there is provided a wiper blade coated with the graphene coating composition for a wiper blade.

According to still another aspect, there is provided a method for manufacturing a wiper blade, the method including coating the graphene coating composition for a wiper blade on a wiper blade.

According to an embodiment, the graphene is contained as the solid lubricant, such that an abrasion resistance and durability of rubber of the wiper blade may be improved at the same time, and a rubber contact life of the wiper blade may be increased.

According to an embodiment, the graphene is contained as the solid lubricant, such that a slip property may be improved by a decrease in coefficient of friction, and the effect of reducing noise and vibrations may be achieved.

According to an embodiment, the graphene and the polyurethane as an optimal binder are contained, such that durability of the wiper blade may be improved. In particular, according to the present application, wiping durability of the wiper blade may be improved.

According to an embodiment, the organic pigment or the pearl pigment having excellent light resistance is used, such that discoloration prevention and long-term storage ability may be improved, and coating of various colors may be implemented.

### BRIEF DESCRIPTION OF THE DRAWINGS

FIG. 1 is a view illustrating a method of measuring a wiper blade when measuring an abrasion resistance of the present disclosure;

FIG. 2 is a graph showing rubber abrasion of graphene and graphite; and

FIG. 3 is a view illustrating a comparison of graphs showing coefficients of friction of graphene and graphite.

### DETAILED DESCRIPTION OF THE DISCLOSURE

The present disclosure may be variously modified and have several embodiments. Therefore, specific embodiments of the present disclosure will be described in detail. However, it is to be understood that the present disclosure is not limited to the specific embodiments, but includes all modifications, equivalents, and substitutions included in the spirit and the scope of the present disclosure. When it is determined that a detailed description for any known art related to the present disclosure may obscure the gist of the present disclosure, the detailed description will be omitted.

In order that the present disclosure may be more readily understood, certain terms are defined the present application for convenience. Unless otherwise defined in the present application, the scientific and technical terms used in the present application will have the meanings generally understood by those skilled in the art. Unless explicitly described otherwise, the term “comprising” used herein means that other elements are not excluded and may be further included.

Hereinafter, the present disclosure will be described in more detail with reference to embodiments. These embodiments are only for explaining the present disclosure in more detail. According to the gist of the present disclosure, it will be apparent to those skilled in the art that the scope of the present disclosure is not limited by these embodiments.

According to an aspect, a graphene coating composition for a wiper blade contains: based on a total weight of the graphene coating composition for a wiper blade, 1 wt % to 16 wt % of a solid lubricant; 80 wt % to 90 wt % of an organic solvent; 2 wt % to 8 wt % of a binder; and 0.5 wt % to 3 wt % of an additive, wherein the solid lubricant contains graphene.

The solid lubricant may be preferably contained in an amount of 1 wt % to 16 wt % based on the total weight of the graphene coating composition for a wiper blade in terms of improvement of durability and an abrasion resistance. The solid lubricant may be more preferably contained in an amount of 6 wt % to 16 wt % and still more preferably contained in an amount of 9 wt % to 16 wt % based on the total weight of the graphene coating composition for a wiper blade. However, the present disclosure is not limited thereto. When the content of the solid lubricant is less than 1 wt %, the durability may be deteriorated, and when the content of the solid lubricant is more than 16 wt %, strength of a coating film of the wiper blade may be lowered and lubricating durability may thus be deteriorated.

In the present application, the solid lubricant contains graphene. The graphene has high elasticity and high strength. More specifically, the graphene has a tensile strength of 20 GPa or more and an elongation of 20% or more. When a solid lubricant containing the graphene is used to manufacture a wiper blade, smooth operability between rubber and a coating surface may be maintained, and a slip property may be improved due to its inherent elasticity. In addition, when graphene is used as a solid lubricant, a smooth and uniform coating surface may be formed and maintained in the wiper blade, and the durability and the abrasion resistance may be improved at the same time.

The graphene may be preferably contained in an amount of 10 wt % to 100 wt % based on a total weight of the solid lubricant in terms of improvement of the abrasion resistance and the slip property of the wiper blade, and the graphene may be more preferably contained in an amount of 50 wt % to 90 wt % and still more preferably contained in an amount of 70 wt % to 90 wt % based on the total weight of the solid lubricant, but the present disclosure is not limited thereto. When the content of the graphene is less than 10 wt % based on the total weight of the solid lubricant, the effect of improving the abrasion resistance, the slip property, and the durability may be insignificant.

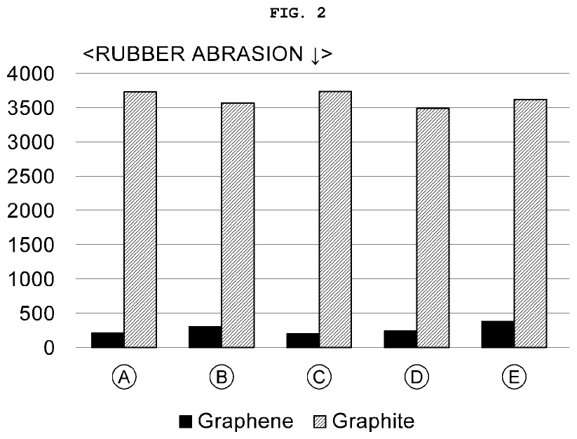

Referring to FIG. 2, it can be seen that a rubber abrasion of graphene is significantly lower than that of graphite. In addition, in a case of a coating composition for a wiper blade that contains graphene, a rubber abrasion resistance of the wiper blade is improved, such that a rubber line contact life may be increased and the durability may be improved.

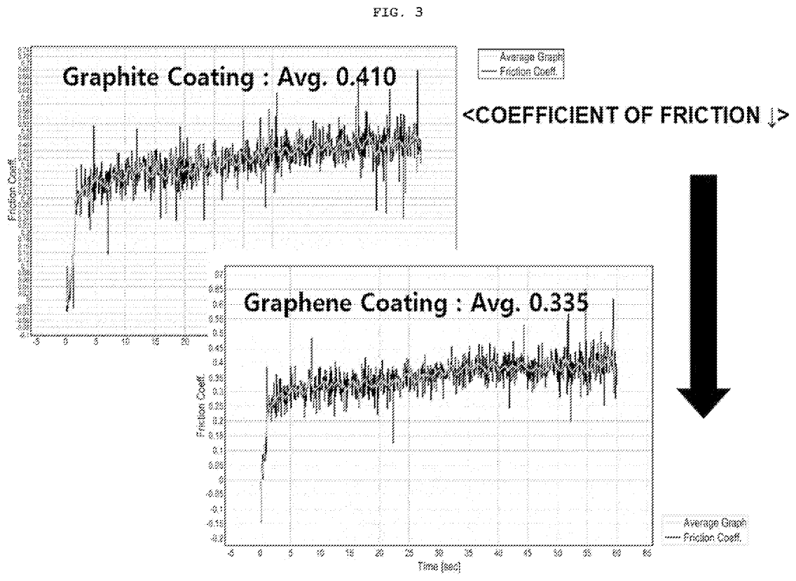

Referring to FIG. 3, graphite coating exhibits an average coefficient of friction of 0.440, and graphene coating exhibits an average coefficient of friction of 0.390. Therefore, it can be confirmed that the coefficient of friction of the graphene coating is smaller than that of the graphite coating, and it is possible to achieve improvement of the slip property of the wiper blade and the effect of reducing noise and vibrations through a decrease in coefficient of friction of the graphene.

In the present disclosure, the solid lubricant essentially contains graphene and contains a binder composition that is optimal for that. Therefore, chattering and noise of the wiper blade may be reduced, and the durability and the abrasion resistance may be improved at the same time.

The organic solvent is not particularly limited as long as it may dissolve a binder, and a known organic solvent may be used. Toluene, methyl ethyl ketone, xylene, ethyl acetate, butyl acetate, ethanol, and a mixture thereof may be used as the organic solvent, but the present disclosure is not limited thereto. As a solvent for dissolving and diluting a binder, solvents that completely dissolve a binder may be used alone or in combination of two or more thereof.

The organic solvent may be preferably contained in an amount of 80 wt % to 90 wt % based on the total weight of the coating composition in terms of improvement of the durability and/or the abrasion resistance of the wiper blade.

The binder may be, but is not limited to, a silicone-based binder, a polyurethane resin, a cellulose resin, a polyamide resin, a polyester resin, or an epoxy resin, and a polyurethane resin may be preferable. Polyurethane is a synthetic polymer compound produced by a polyaddition reaction by which urethane linkages are repeatedly formed by diisocyanate and dialcohol, and has the urethane linkages inside a main chain. The polyurethane resin is easy to use and has an excellent abrasion resistance, flatness, plastering properties, flexibility, and adhesion.

The binder may be preferably contained in an amount of 2 wt % to 8 wt % based on the total weight of the coating composition in terms of improvement of the durability and/or the abrasion resistance of the wiper blade. However, the present disclosure is not limited thereto. When the content of the binder in the coating composition is less than 2 wt %, it is difficult to obtain a sufficient abrasion resistance, and when the binder is contained in a large amount of more than 8 wt %, streaks and noise may easily occur due to marks generated after wiping with the wiper blade. In addition, when the binder is contained in the coating composition in a large amount of more than 8 wt %, the solid lubricant is contained in a relatively small amount. Therefore, when sand is attached to the wiper blade, the coefficient of friction is rapidly increased, which may cause deterioration of sliding properties.

The additive may be an additive such as a dispersing agent, a defoaming agent, a leveling agent, an emulsifier, an ultraviolet absorber, or an anti-settling agent. In addition, the additive may further include a filer such as kaolin, talc, silica, calcium carbonate, mica, titanium dioxide, alumina, urethane rubber powder, or acrylic powder. The dispersing agent and the anti-settling agent may be preferably contained in the additive in an amount of 0.5 wt % to 3 wt % in terms of improvement of wiping durability and the abrasion resistance of the wiper blade.

The solid lubricant may further contain one or more selected from graphite and boron nitride.

Graphite has a hexagonal columnar layer lattice structure, and has a high compressive strength in a direction perpendicular to a plane because atoms are covalently bonded inside a layer thereof. On the other hand, graphite has a low shear strength in a direction parallel to the layer because a Van der Waals bond is formed between the layers. Due to these characteristics, graphite is used as a representative solid lubricant, has excellent high-temperature stability, and exhibits excellent lubricating properties in a humid environment. In addition, graphite has a low coefficient of friction under a high load.

Boron nitride has a crystal structure similar to that of pyrolytic carbon, has significantly excellent oxidation resistance, and forms boron oxide (B₂O₃) when being oxidized, and the formed boron oxide exhibits a self-healing function at a high temperature. Therefore, boron nitride may be suitable for interface control coating. In addition, boron nitride is called white graphite, has excellent machinability, and has a hexagonal structure similar to graphite. Therefore, boron nitride has chemical and physical properties similar to those of graphite. However, a difference between two materials is that boron nitride is white and is an electrically excellent insulator, and graphite is an electrical conductor.

The graphene may be contained in an amount of 10 wt % to 90 wt % based on the total weight of the solid lubricant, and the graphite may be contained in an amount of 10 wt % to 90 wt % based on the total weight of the solid lubricant. In a case of a coating composition having a composition within the above range, a wiping durability grade (100,000 cycles) of the wiper blade is 8/9 to 9/9, and a wiping durability grade (200,000 cycles) of the wiper blade is 8/8 to 8/9, which shows that the wiping durability grade of the wiper blade is excellent. It may be more preferable that the graphene is contained in an amount of 20 wt % to 80 wt % based on the total weight of the solid lubricant, and the graphite is contained in an amount of 20 wt % to 80 wt % based on the total weight of the solid lubricant, in terms of improvement of the durability and the abrasion resistance (Examples 3 and 8 to 10), but the present disclosure is not limited thereto. It may be still more preferable that the graphene is contained in an amount of 65 wt % to 85 wt % based on the total weight of the solid lubricant, and the graphite is contained in an amount of 15 wt % to 35 wt % based on the total weight of the solid lubricant, in terms of improvement of the durability and the abrasion resistance (Examples 9 and 11).

The graphene may be contained in an amount of 40 wt % to 85 wt % based on the total weight of the solid lubricant, and the boron nitride may be contained in an amount of 15 wt % to 60 wt % based on the total weight of the solid lubricant. In a case of a coating composition having a composition within the above range, the wiping durability grade (100,000 cycles) of the wiper blade is 8/9, and the wiping durability grade (200,000 cycles) of the wiper blade is 8/8 to 8/9, which shows that the wiping durability grade of the wiper blade is excellent (Examples 4 and 15). In addition, when the graphene is contained in an amount of 75 wt % to 85 wt % based on the total weight of the solid lubricant and the boron nitride is contained in an amount of 15 wt % to 25 wt % based on the total weight of the solid lubricant, the effect of improving the abrasion resistance is also excellent (Example 15).

The solid lubricant may further contain one or more selected from silicone powder, Teflon powder, PE powder, and a pigment.

The silicone powder, which is flexible powder having a significantly excellent slip property, is an elastic material in which dimethyl silicone is cross-linked, and may provide lubricity and smoothness in the graphene coating composition for a wiper blade and may provide chattering stability at the same time.

The Teflon powder is known to have excellent chemical resistance among organic materials, and may improve resistance to friction generated between glass and rubber for a wiper while providing high durability against influences of bad weather, aging, chemicals, and temperature.

When the graphene is contained in an amount of 70 wt % to 90 wt % based on the total weight of the solid lubricant, the graphite is contained in an amount of 10 wt % to 30 wt % based on the total weight of the solid lubricant, and the Teflon powder is contained in an amount of 0.1 wt % to 1 wt % based on the total weight of the graphene coating composition for a wiper blade, the wiping durability grades (100,000 cycles and 200,000 cycles) of the wiper blade are 9/9, which shows that the effect of improving the durability is most excellent (Example 13), but the present disclosure is not limited thereto. In addition, in a case of a coating composition having a composition within the above range, the abrasion resistance is 250 to 270, which shows that the effect of improving the abrasion resistance is also most excellent (Example 13).

Since the PE (Polyethylene) powder has a significantly high molecular weight and a low coefficient of dry friction, the PE powder may be preferable for coating a rubber lip of a wiper blade.

The pigment may include a pearl pigment or an organic pigment.

The pearl pigment is a plate-shaped crystal having a squareness ratio, unlike a general organic pigment or inorganic pigment. Reflected light generated by a difference between a refractive index of the plate-shaped crystal and a refractive index of a medium causes interference. Accordingly, the pearl pigment is an effect pigment having an optical effect providing a pearlescent or metallic luster like natural pearl. The properties of the pearl pigment have a size, shape, and thickness, are transmissive and reflective, and have an interference effect by light.

The organic pigment is a pigment in which an organic substance is used as a colored component. A pigment obtained by precipitating an insoluble salt on an extender pigment is referred to as a lake pigment.

In addition, a pigment prepared using a dye synthesis technique is referred to as a synthetic organic pigment (coloring pigment). Unlike the inorganic pigment, the organic pigment and the synthetic organic pigment have vivid colors and excellent tinting strength, but are poor in light resistance and heat resistance. A basic skeleton of the organic pigment is composed of covalent bonds of carbon-carbon and carbon-hydrogen. A particle size of the pigment may be 9 μm to 40 μm.

A diameter of the pigment may be preferably 9 μm to 40 μm in terms of preventing fading or discoloration of the wiper blade, and a color of the pigment may be gold or silver, but the present disclosure is not limited thereto.

The graphene may be contained in an amount of 70 wt % to 90 wt % based on the total weight of the solid lubricant, the graphite may be contained in an amount of 10 wt % to 30 wt % based on the total weight of the solid lubricant, and the one or more selected from silicone powder, Teflon powder, PE powder, and a pigment may be contained in an amount of 0 wt % to 1 wt % based on the total weight of the graphene coating composition for a wiper blade. In a case of a coating composition having a composition within the above range, the wiping durability grade (100,000 cycles) of the wiper blade is 9/8 to 9/9, and the wiping durability grade (200,000 cycles) of the wiper blade is 9/8 to 9/9, which shows that the wiping durability grade of the wiper blade is excellent (Examples 12 to 14). In addition, in a case of a coating composition having a composition within the above range, the abrasion resistance is 250 to 500, which shows that the effect of improving the abrasion resistance is also significantly excellent (Examples 12 to 14).

The graphene may be contained in an amount of 70 wt % to 90 wt % based on the total weight of the solid lubricant, the boron nitride may be contained in an amount of 10 wt % to 30 wt % based on the total weight of the solid lubricant, and the one or more selected from silicone powder, Teflon powder, PE powder, and a pigment may be contained in an amount of 0 wt % to 1 wt % based on the total weight of the graphene coating composition for a wiper blade. In a case of a coating composition having a composition within the above range, the wiping durability grade (100,000 cycles) of the wiper blade is 8/9, and the wiping durability grade (200,000 cycles) of the wiper blade is 8/8, which shows that the wiping durability grade of the wiper blade is excellent (Example 15). In addition, in a case of a coating composition having a composition within the above range, the abrasion resistance is 500 to 520, which shows that the effect of improving the abrasion resistance is also excellent (Example 15).

As described above, the graphene coating composition for a wiper blade of the present application may improve wiping durability of the wiper blade and one or more of an abrasion resistance and a slip property.

According to another aspect, there is provided a wiper blade coated with the graphene coating composition for a wiper blade of the present application.

The wiper blade of the present application may be formed of silicone rubber or general rubber. The general rubber may be composed of, but is not limited to, one or more of natural rubber, butadiene rubber, styrene-butadiene rubber, EPDM rubber, and chloroprene rubber. A material of the wiper blade of the present application is not particularly limited as long as it satisfies required performances such as adhesion to rubber and conformability to rubber extensibility, and materials may be used alone or in combination of two or more thereof.

The wiper blade coated with the graphene coating composition for a wiper blade of the present application may improve an abrasion resistance and durability of rubber of the wiper blade at the same time and may have an increased rubber contact life of the wiper blade. In addition, the wiper blade may achieve improvement of the slip property and the effect of reducing noise and vibrations through the decrease in coefficient of friction.

The graphene coating composition for a wiper blade of the present application may be used for one or more of a hose, a cable plug, a traction cable, and an external cable, in addition to the wiper blade.

According to still another aspect, there is provided a method for manufacturing a wiper blade, the method including coating the graphene coating composition for a wiper blade on a wiper blade.

The coating of the graphene coating composition for a wiper blade on the wiper blade may be performed by a known coating method, for example, a spraying method or a dipping method.

When the coating is performed by the spraying method, coating equipment is relatively simple, a continuous process is preferably performed, and a more uniform coating surface is formed than the coating performed by the dipping method, but the amount of coating liquid consumed is large and the coating liquid is scattered.

In the embodiments of the present application, the coating composition of the present application is sprayed onto a surface of wiper blade rubber with a spray gun at a constant height, speed, and spray amount, and then, a coating film is cured through thermal curing (by a drying furnace) at room temperature.

Hereinafter, the present disclosure will be described in detail with reference to examples. However, the following examples illustrate only the present disclosure, and the present disclosure is not limited by the following examples.

### EXAMPLES

1. Preparation of Coating Composition for Wiper Blade

Coating compositions for a wiper blade of Comparative Example 1 and Example 1 were prepared as follows according to the compositions shown in Tables 1 and 2. A unit of the content of each of the components shown in Tables 1 and 2 is wt %.

1-1. Coating Composition of Comparative Example 1

The coating composition for a wiper blade of Comparative Example 1 was prepared by mixing and dispersing 3 wt % of a polyurethane (PU) resin, 83 wt % of toluene, 13.5 wt % of graphite as a solid lubricant, and 0.5 wt % of additives (a leveling agent and a dispersing agent). In Comparative Example 1, graphene was not contained.

1-2. Coating Composition of Example 1

The coating composition for a wiper blade of Example 1 was prepared by mixing and dispersing 3 wt % of a polyurethane resin, 83 wt % of toluene, 13.5 wt % of graphene as a solid lubricant, and 0.5 wt % of additives (a leveling agent and a dispersing agent). The graphene was contained in an amount of wt % to 100 wt % based on a total weight of the solid lubricant. In Example 1, graphite was not contained.

TABLE 1

| Order | Classification | Binder | Graphene | Graphite |
|---|---|---|---|---|
| Selection of | Comparative | PU | — | 100% |
| Binder | Example 1 | | | |
| | Example 1 | PU | 100% | — |

TABLE 2

| | | Comparative | |
|---|---|---|---|
| Category | | Example 1 | Example 1 |
| Binder | Polyurethane Resin | 3 | 3 |
| Solvent | Toluene | 83 | 83 |
| Solid Lubricant | Graphene | 0 | 13.5 |
| | Graphite | 13.5 | 0 |
| Additive | Leveling Agent and | 0.5 | 0.5 |
| | Dispersing Agent | | |

| | | |
|---|---|---|
| Total | 100 | 100 |

2. Preparation of Coating Composition for Wiper Blade Containing Graphene

Coating compositions for a wiper blade containing graphene of Examples 2 to 7 were prepared as follows according to the compositions shown in Tables 3 and 4. A unit of the content of each of the components shown in Tables 3 and 4 is wt %.

2-1. Coating Compositions of Examples 2 to 7

In all the coating compositions for a wiper blade of Examples 2 to 7, graphene was contained. In Example 3, the graphene was contained in an amount of 50 wt % based on a total weight of a solid lubricant, and the graphite was contained in an amount of 50 wt % based on the total weight of the solid lubricant. In Example 4, the graphene was contained in an amount of 50 wt % based on the total weight of the solid lubricant, and the boron nitride was contained in an amount of 50 wt % based on the total weight of the solid lubricant.

More specifically, it is as follows.

The coating composition for a wiper blade of Example 2 was prepared by mixing and dispersing 3 wt % of a polyurethane resin, 85 wt % of toluene, 11.5 wt % of graphene as a solid lubricant, and 0.5 wt % of additives (a leveling agent and a dispersing agent). In Example 2, graphite and boron nitride were not contained.

The coating composition for a wiper blade of Example 3 was prepared by mixing and dispersing 3 wt % of a polyurethane resin, 85 wt % of toluene, 5.75 wt % of graphene and 5.75 wt % of graphite as solid lubricants, and 0.5 wt % of additives (a leveling agent and a dispersing agent). In Example 3, boron nitride was not contained.

The coating composition for a wiper blade of Example 4 was prepared by mixing and dispersing 3 wt % of a polyurethane resin, 85 wt % of toluene, 5.75 wt % of graphene and 5.75 wt % of boron nitride as solid lubricants, and 0.5 wt % of additives (a leveling agent and a dispersing agent). In Example 4, graphite was not contained.

The coating composition for a wiper blade of Example 5 was prepared by mixing and dispersing 3 wt % of a polyurethane resin, 95.5 wt % of toluene, 1 wt % of graphene as a solid lubricant, and 0.5 wt % of additives (a leveling agent and a dispersing agent). In Example 5, graphite and boron nitride were not contained.

The coating composition for a wiper blade of Example 6 was prepared by mixing and dispersing 3 wt % of a polyurethane resin, 89.5 wt % of toluene, 7 wt % of graphene as a solid lubricant, and 0.5 wt % of additives (a leveling agent and a dispersing agent). In Example 6, graphite and boron nitride were not contained.

The coating composition for a wiper blade of Example 7 was prepared by mixing and dispersing 3 wt % of a polyurethane resin, 80.5 wt % of toluene, 16 wt % of graphene as a solid lubricant, and 0.5 wt % of additives (a leveling agent and a dispersing agent). In Example 7, graphite and boron nitride were not contained.

TABLE 3

| | | | | | Boron |
|---|---|---|---|---|---|
| Order | Classification | Binder | Graphene | Graphite | Nitride |
| 1^{st} | Example 2 | PU | 100% | | |
| | Example 3 | PU | 50% | 50% | |
| | Example 4 | PU | 50% | | 50% |
| | Example 5 | PU | 100% | | |
| | Example 6 | PU | 100% | | |
| | Example 7 | PU | 100% | | |

TABLE 4

| | | Example | Example | Example | Example | Example | Example |
|---|---|---|---|---|---|---|---|
| Category | | 2 | 3 | 4 | 5 | 6 | 7 |
| Binder | Polyurethane Resin | 3 | 3 | 3 | 3 | 3 | 3 |
| Solvent | Toluene | 85 | 85 | 85 | 95.5 | 89.5 | 80.5 |
| Solid | Graphene | 11.5 | 5.75 | 5.75 | 1 | 7 | 16 |
| Lubricant | Graphite | 0 | 5.75 | 0 | 0 | 0 | 0 |
| | Boron Nitride | 0 | 0 | 5.75 | 0 | 0 | 0 |
| Additive | Leveling Agent and | 0.5 | 0.5 | 0.5 | 0.5 | 0.5 | 0.5 |
| | Dispersing Agent | | | | | | |

| | | | | | | |
|---|---|---|---|---|---|---|
| Total | 100 | 100 | 100 | 100 | 100 | 100 |

3. Preparation of Coating Composition for Wiper Blade Containing Graphene and Graphite

Coating compositions for a wiper blade containing graphene and graphite of Examples 8 to 11 were prepared as follows according to the compositions shown in Tables 5 and 6. A unit of the content of each of the components shown in Tables 5 and 6 is wt %.

3-1. Coating Compositions of Examples 8 to 11

In all the coating compositions for a wiper blade of Examples 8 to 11, graphene and graphite were contained. In the coating compositions for a wiper blade of Examples 8 to 11, the graphene was contained in an amount of 20 wt % to 80 wt % based on a total weight of a solid lubricant, and the graphite was contained in an amount of 20 wt % to 80 wt % based on the total weight of the solid lubricant.

More specifically, it is as follows. In Examples 8 to 11, boron nitride was not contained.

The coating composition for a wiper blade of Example 8 was prepared by mixing and dispersing 3 wt % of a polyurethane resin, 85 wt % of toluene, 3.8 wt % of graphene, 7.7 wt % of graphite, and 0.5 wt % of additives (a leveling agent and a dispersing agent).

The coating composition for a wiper blade of Example 9 was prepared by mixing and dispersing 3 wt % of a polyurethane resin, 85 wt % of toluene, 7.7 wt % of graphene, 3.8 wt % of graphite, and 0.5 wt % of additives (a leveling agent and a dispersing agent).

The coating composition for a wiper blade of Example 10 was prepared by mixing and dispersing 3 wt % of a polyurethane resin, 85 wt % of toluene, 4.5 wt % of graphene, 7 wt % of graphite, and 0.5 wt % of additives (a leveling agent and a dispersing agent).

The coating composition for a wiper blade of Example 11 was prepared by mixing and dispersing 3 wt % of a polyurethane resin, 85 wt % of toluene, 7 wt % of graphene, 4.5 wt % of graphite, and 0.5 wt % of additives (a leveling agent and a dispersing agent).

TABLE 5

| Order | Classification | Binder | Graphene | Graphite |
|---|---|---|---|---|
| 2^{nd} | Example 8 | PU | 20% | 80% |
| | Example 9 | PU | 80% | 20% |
| | Example 10 | PU | 30% | 70% |
| | Example 11 | PU | 70% | 30% |

TABLE 6

| | | Example | Example | Example | Example |
|---|---|---|---|---|---|
| Category | | 8 | 9 | 10 | 11 |
| Binder | Polyurethane | 3 | 3 | 3 | 3 |
| | Resin | | | | |
| Solvent | Toluene | 85 | 85 | 85 | 85 |
| Solid | Graphene | 3.8 | 7.7 | 4.5 | 7 |
| Lubricant | Graphite | 7.7 | 3.8 | 7 | 4.5 |
| | Boron | 0 | 0 | 0 | 0 |
| | Nitride | | | | |
| Additive | Leveling | 0.5 | 0.5 | 0.5 | 0.5 |
| | Agent and | | | | |
| | Dispersing | | | | |
| | Agent | | | | |

| | | | | |
|---|---|---|---|---|
| Total | 100 | 100 | 100 | 100 |

4. Preparation of Graphene Coating Compositions for Wiper Blade Containing Additional Additive

Coating compositions for a wiper blade containing graphene and graphite of Examples 12 to 15 were prepared as follows according to the compositions shown in Tables 7 and 8. A unit of the content of each of the components shown in Tables 7 and 8 is wt %.

4-1. Coating Compositions of Examples 12 to 15

In all the coating compositions for a wiper blade of Examples 12 to 15, graphene was contained, graphite or boron nitride was contained, and one selected from the group consisting of silicone powder, Teflon powder, PE powder, and a pearl pigment was contained as an additional additive. In the coating compositions for a wiper blade of Examples 12 to 14, the graphene was contained in an amount of 80 wt % based on a total weight of a solid lubricant, the graphite was contained in an amount of 20 wt % based on the total weight of the solid lubricant, and the one or more selected from silicone powder, Teflon powder, PE powder, and a pigment were contained in an amount of 0.2 wt % based on a total weight of the coating composition for a wiper blade.

In the coating composition for a wiper blade of Example 15, the graphene was contained in an amount of 80 wt % based on the total weight of the solid lubricant, the boron nitride was contained in an amount of 20 wt % based on the total weight of the solid lubricant, and the one or more selected from silicone powder, Teflon powder, PE powder, and a pigment were contained in an amount of 0.2 wt % based on the total weight of the coating composition for a wiper blade.

More specifically, it is as follows.

The coating composition for a wiper blade of Example 12 was prepared by mixing and dispersing 3 wt % of a polyurethane resin, 85 wt % of toluene, 9 wt % of graphene, 2.3 wt % of graphite, 0.2 wt % of silicone powder, and 0.5 wt % of additives (a leveling agent and a dispersing agent). In Example 12, boron nitride, Teflon powder, PE powder, and a pearl pigment were not contained.

The coating composition for a wiper blade of Example 13 was prepared by mixing and dispersing 3 wt % of a polyurethane resin, 85 wt % of toluene, 9 wt % of graphene, 2.3 wt % of graphite, 0.2 wt % of Teflon powder, and 0.5 wt % of additives (a leveling agent and a dispersing agent). In Example 14, boron nitride, silicone powder, PE powder, and a pearl pigment were not contained.

The coating composition for a wiper blade of Example 14 was prepared by mixing and dispersing 3 wt % of a polyurethane resin, 85 wt % of toluene, 9 wt % of graphene, 2.3 wt % of graphite, 0.2 wt % of PE powder, and 0.5 wt % of additives (a leveling agent and a dispersing agent). In Example 14, boron nitride, silicone powder, Teflon powder, and a pearl pigment were not contained.

The coating composition for a wiper blade of Example 15 was prepared by mixing and dispersing 3 wt % of a polyurethane resin, 85 wt % of toluene, 9 wt % of graphene, 2.3 wt % of boron nitride, 0.2 wt % of a pearl pigment, and 0.5 wt % of additives (a leveling agent and a dispersing agent). In Example 15, graphite, silicone powder, Teflon powder, and PE powder were not contained.

TABLE 7

| | Classifi- | Graph- | Graph- | | Sili- | Tef- | | Gold |
|---|---|---|---|---|---|---|---|---|
| Order | cation | ene | ite | BN | cone | lon | PE | Pearl |
| 3^{rd} | Example 12 | 80% | 20% | | ∘ | | | |
| | Example 13 | 80% | 20% | | | ∘ | | |
| | Example 14 | 80% | 20% | | | | ∘ | |
| | Example 15 | 80% | | 20% | | | | ∘ |

TABLE 8

| | | Example | Example | Example | Example |
|---|---|---|---|---|---|
| Category | | 12 | 13 | 14 | 15 |
| Binder | Polyurethane | 3 | 3 | 3 | 3 |
| | Resin | | | | |
| Solvent | Toluene | 85 | 85 | 85 | 85 |
| Solid | Graphene | 9 | 9 | 9 | 9 |
| Lubricant | Graphite | 2.3 | 2.3 | 2.3 | 0 |
| | Boron | 0 | 0 | 0 | 2.3 |
| | Nitride | | | | |
| | Silicone | 0.2 | 0 | 0 | 0 |
| | Powder | | | | |
| | Teflon | 0 | 0.2 | 0 | 0 |
| | Powder | | | | |
| | PE Powder | 0 | 0 | 0.2 | 0 |
| | Pearl | 0 | 0 | 0 | 0.2 |
| | Pigment (9 | | | | |
| | to 40 μm) | | | | |
| Additive | Leveling | 0.5 | 0.5 | 0.5 | 0.5 |
| | Agent and | | | | |
| | Dispersing | | | | |
| | Agent | | | | |

| | | | | |
|---|---|---|---|---|
| Total | 100 | 100 | 100 | 100 |

5. Coating of Wiper Blade

Each of the coating compositions for a wiper blade was coated on a wiper blade using a spraying method as one of general coating methods.

The coating composition of the present application was sprayed onto a surface of wiper blade rubber with a spray gun at a constant height, speed, and spray amount, and then, a coating film was cured through thermal curing (by a drying furnace) at room temperature.

Then, the following experiments were conducted to determine the durability and the abrasion resistance of the wiper blade.

### Experimental Example 1. Measurement of Wiping Durability Grade

A tester based on a tester used for evaluating the performance of wiper blades as prescribed in JIS D5710 was used. The wiper blades were operated 500,000 cycles in a state where water was uniformly sprayed at 500 cc/min. The operating speed of the wiper blades was set to 40 cycle/min. The evaluation was carried to determine wiping performance and the presence or absence of noise after performing the operations 100,000, 200,000, 300,000, and 500,000 cycles. In addition, the wiping performance was evaluated when the wiper blades were closed. In a case where vibrations of the wiper blades were significant and operations of the wiper blades were not smooth, the test was suspended. The evaluation reference table for wiping durability is as in Table 9.

### Experimental Example 2. Measurement of Abrasion Resistance

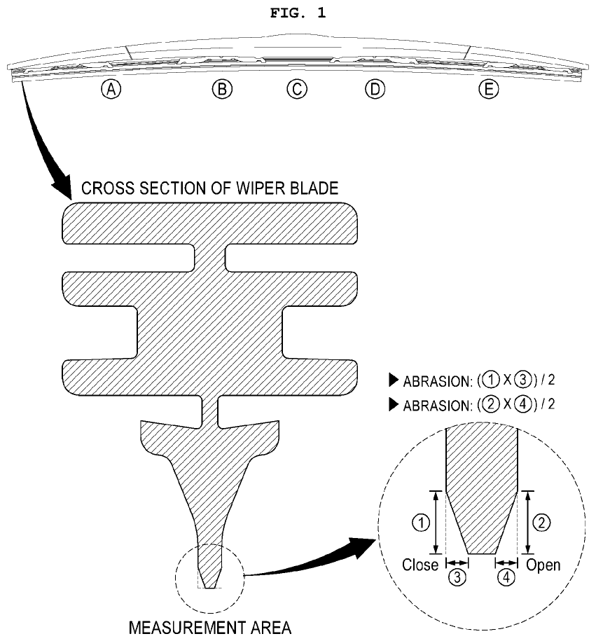

An abrasion area of a cut surface at each of 5 points (\textcircled{A}˜\textcircled{E}) of a wiper ES durable item was measured. The measurement data was measured with reference to FIG. 1 as the measurement area. The abrasion of the wiper blade durable item was evaluated based on 2,000 (μm²). Referring to FIG. 1, the abrasion was evaluated when the wiper blades were closed and opened. The abrasion was calculated by (\textcircled{1}×\textcircled{3})/2 when the wiper blades were closed, and the abrasion was calculated by (\textcircled{2}×\textcircled{4})/2 when the wiper blades were opened. During the test, in a case where vibrations of the wiper blades were significant and operations of the wiper blades were not smooth, the test was suspended.

In addition, the initial wiping grade measurement test, the wiping durability grade measurement test, and the abrasion resistance measurement test of the wiper blades obtained from Examples and Comparative Examples were conducted by the same methods as described above. The results thereof are shown in Tables 10 to 12.

As shown in Table 10, it was confirmed that the wiping durability grade (200,000 cycles) of Example 1 in which graphene was contained was 8/8, which showed that the wiping durability grade (200,000 cycles) of Example 1 was superior to that of Comparative Example 1 in which graphite was contained.

In addition, the abrasion resistance (Close) and the abrasion resistance (Open) of Example 1 in which graphene was contained were 840 and 818, respectively, which were significantly lower than those in Comparative Example 1 in which the abrasion resistance (Close) and the abrasion resistance (Open) were 3,581 and 3,561, respectively. Therefore, it was confirmed that excellent abrasion resistance was exhibited in Example 1.

As shown in Table 11, the initial wiping grade, the wiping durability grade (100,000 cycles), the wiping durability grade (200,000 cycles), the abrasion resistance (Close), and the abrasion resistance (Open) of Examples 2 to 7 in which graphene was contained were measured.

The coating composition for a wiper blade of Example 2 was prepared by mixing and dispersing 3 wt % of a polyurethane resin, 85 wt % of toluene, 11.5 wt % of graphene, and 0.5 wt % of additives (a leveling agent and a dispersing agent) without containing graphite and boron nitride. The wiping durability grade (100,000 cycles) and the wiping durability grade (200,000 cycles) were 9/8 and 8/8, respectively, and the abrasion resistance (Close) and the abrasion resistance (Open) were 813 and 822, respectively.

The coating composition for a wiper blade of Example 3 was prepared by mixing and dispersing 3 wt % of a polyurethane resin, 85 wt % of toluene, 5.75 wt % of graphene, 5.75 wt % of graphite, and 0.5 wt % of additives (a leveling agent and a dispersing agent) without containing boron nitride. The wiping durability grade (100,000 cycles) and the wiping durability grade (200,000 cycles) were 9/8 and 9/8, respectively, which showed that the wiping durability was superior to that of Comparative Example 1. The abrasion resistance (Close) and the abrasion resistance (Open) were 626 and 615, respectively, which showed that the abrasion resistance was superior to those of Comparative Example 1, and Examples 1 and 2, and 4 to 7.

The coating composition for a wiper blade of Example 4 was prepared by mixing and dispersing 3 wt % of a polyurethane resin, 85 wt % of toluene, 5.75 wt % of graphene, 5.75 wt % of boron nitride, and 0.5 wt % of additives (a leveling agent and a dispersing agent) without containing graphite. The wiping durability grade (100,000 cycles) and the wiping durability grade (200,000 cycles) were 8/9 and 8/9, respectively, and the abrasion resistance (Close) and the abrasion resistance (Open) were 670 and 662, respectively.

The coating composition for a wiper blade of Example 5 was prepared by mixing and dispersing 3 wt % of a polyurethane resin, 95.5 wt % of toluene, 1 wt % of graphene, and 0.5 wt % of additives (a leveling agent and a dispersing agent) without containing graphite and boron nitride. The wiping durability grade (100,000 cycles) and the wiping durability grade (200,000 cycles) were 8/9 and 8/7, respectively, and the abrasion resistance (Close) and the abrasion resistance (Open) were 1,306 and 1,303, respectively.

The coating composition for a wiper blade of Example 6 was prepared by mixing and dispersing 3 wt % of a polyurethane resin, 89.5 wt % of toluene, 7 wt % of graphene, and 0.5 wt % of additives (a leveling agent and a dispersing agent) without containing graphite and boron nitride. The wiping durability grade (100,000 cycles) and the wiping durability grade (200,000 cycles) were 8/9 and 8/8, respectively, and the abrasion resistance (Close) and the abrasion resistance (Open) were 1,036 and 1,062, respectively.

The coating composition for a wiper blade of Example 7 was prepared by mixing and dispersing 3 wt % of a polyurethane resin, 80.5 wt % of toluene, 16 wt % of graphene, and 0.5 wt % of additives (a leveling agent and a dispersing agent) without containing graphite and boron nitride. The wiping durability grade (100,000 cycles) and the wiping durability grade (200,000 cycles) were 8/8 and 7/8, respectively, and the abrasion resistance (Close) and the abrasion resistance (Open) were 1,258 and 1,066, respectively.

TABLE 12

| | | | Wiping | Wiping | Abra- | Abra- |
|---|---|---|---|---|---|---|
| | | | Durability | Durability | sion | sion |
| | | Initial | Grade | Grade | Resis- | Resis- |
| | Classifi- | Wiping | (100,000 | (200,000 | tance | tance |
| | cation | Grade | Cycles) | Cycles) | (Close) | (Open) |
| ES | Example 8 | 10/10 | 9/9 | 8/8 | 744 | 730 |
| | Example 9 | 10/10 | 9/9 | 9/8 | 517 | 528 |
| | Example 10 | 10/10 | 8/9 | 8/8 | 673 | 678 |
| | Example 11 | 10/10 | 8/9 | 8/8 | 567 | 557 |

* Abrasion Resistance Value: Average Value of 5 Points

As shown in Table 12, the initial wiping grade, the wiping durability grade (100,000 cycles), the wiping durability grade (200,000 cycles), the abrasion resistance (Close), and the abrasion resistance (Open) of Examples 8 to 11 in which both graphene and graphite were contained were measured.

The coating composition for a wiper blade of Example 8 was prepared by mixing and dispersing 3 wt % of a polyurethane resin, 85 wt % of toluene, 3.8 wt % of graphene, 7.7 wt % of graphite, and 0.5 wt % of additives (a leveling agent and a dispersing agent) without containing boron nitride. The wiping durability grade (100,000 cycles) and the wiping durability grade (200,000 cycles) were 9/9 and 8/8, respectively, and the abrasion resistance (Close) and the abrasion resistance (Open) were 744 and 730, respectively.

The coating composition for a wiper blade of Example 9 was prepared by mixing and dispersing 3 wt % of a polyurethane resin, 85 wt % of toluene, 7.7 wt % of graphene, 3.8 wt % of graphite, and 0.5 wt % of additives (a leveling agent and a dispersing agent) without containing boron nitride. The wiping durability grade (100,000 cycles) and the wiping durability grade (200,000 cycles) were 9/9 and 9/8, respectively, and the abrasion resistance (Close) and the abrasion resistance (Open) were 517 and 528, respectively, which showed that the abrasion resistance was superior to those of Comparative Example 1, and Examples 1 to 8, 10, and 11.

The coating composition for a wiper blade of Example 10 was prepared by mixing and dispersing 3 wt % of a polyurethane resin, 85 wt % of toluene, 4.5 wt % of graphene, 7 wt % of graphite, and 0.5 wt % of additives (a leveling agent and a dispersing agent). The wiping durability grade (100,000 cycles) and the wiping durability grade (200,000 cycles) were 8/9 and 8/8, respectively, and the abrasion resistance (Close) and the abrasion resistance (Open) were 673 and 678, respectively.

The coating composition for a wiper blade of Example 11 was prepared by mixing and dispersing 3 wt % of a polyurethane resin, 85 wt % of toluene, 7 wt % of graphene, 4.5 wt % of graphite, and 0.5 wt % of additives (a leveling agent and a dispersing agent). The wiping durability grade (100,000 cycles) and the wiping durability grade (200,000 cycles) were 8/9 and 8/8, respectively, and the abrasion resistance (Close) and the abrasion resistance (Open) were 567 and 557, respectively.

TABLE 13

| | | | Wiping | Wiping | Abra- | Abra- |
|---|---|---|---|---|---|---|
| | | | Durability | Durability | sion | sion |
| | | Initial | Grade | Grade | Resis- | Resis- |
| | Classifi- | Wiping | (100,000 | (200,000 | tance | tance |
| | cation | Grade | Cycles) | Cycles) | (Close) | (Open) |
| ES | Example 12 | 10/10 | 9/8 | 9/8 | 498 | 428 |
| | Example 13 | 10/10 | 9/9 | 9/9 | 252 | 268 |
| | Example 14 | 10/10 | 9/9 | 9/8 | 455 | 433 |
| | Example 15 | 10/10 | 8/9 | 8/8 | 519 | 501 |

* Abrasion Resistance Value: Average Value of 5 Points

As shown in Table 13, the initial wiping grade, the wiping durability grade (100,000 cycles), and the wiping durability grade (200,000 cycles) of Examples 12 to 15 in which one or more selected from the group consisting of graphene, graphite, boron nitride, silicone powder, Teflon powder, PE powder, and a pearl pigment were contained were measured.

The coating composition for a wiper blade of Example 12 was prepared by mixing and dispersing 3 wt % of a polyurethane resin, 85 wt % of toluene, 9 wt % of graphene, 2.3 wt % of graphite, 0.2 wt % of silicone powder, and 0.5 wt % of additives (a leveling agent and a dispersing agent) without containing boron nitride, Teflon powder, PE powder, and a pearl pigment. The wiping durability grade (100,000 cycles) and the wiping durability grade (200,000 cycles) were 9/8 and 9/8, respectively, and the abrasion resistance (Close) and the abrasion resistance (Open) were 498 and 428, respectively, which were significantly excellent.

The coating composition for a wiper blade of Example 13 was prepared by mixing and dispersing 3 wt % of a polyurethane resin, 85 wt % of toluene, 9 wt % of graphene, 2.3 wt % of graphite, 0.2 wt % of Teflon powder, and 0.5 wt % of additives (a leveling agent and a dispersing agent) without containing boron nitride, silicone powder, PE powder, and a pearl pigment. The wiping durability grade (100,000 cycles) and the wiping durability grade (200,000 cycles) were 9/9 and 9/9, respectively, which showed that the wiping durability was most superior to those of Comparative Example 1 and Examples 1 to 12, 14, and 15. In addition, the abrasion resistance (Close) and the abrasion resistance (Open) were 252 and 268, respectively, which showed that the abrasion resistance was most superior to those of Comparative Example 1 and Examples 1 to 12, 14, and 15.

The coating composition for a wiper blade of Example 14 was prepared by mixing and dispersing 3 wt % of a polyurethane resin, 85 wt % of toluene, 9 wt % of graphene, 2.3 wt % of graphite, 0.2 wt % of PE powder, and 0.5 wt % of additives (a leveling agent and a dispersing agent) without containing boron nitride, silicone powder, Teflon powder, and a pearl pigment. The wiping durability grade (100,000 cycles) and the wiping durability grade (200,000 cycles) were 9/9 and 9/8, respectively, and the abrasion resistance (Close) and the abrasion resistance (Open) were 455 and 433, respectively, which were significantly excellent.

The coating composition for a wiper blade of Example 15 was prepared by mixing and dispersing 3 wt % of a polyurethane resin, 85 wt % of toluene, 9 wt % of graphene, 2.3 wt % of boron nitride, 0.2 wt % of a pearl pigment, and 0.5 wt % of additives (a leveling agent and a dispersing agent) without containing silicone powder, Teflon powder, and PE powder. The wiping durability grade (100,000 cycles) and the wiping durability grade (200,000 cycles) were 8/9 and 8/8, respectively, and the abrasion resistance (Close) and the abrasion resistance (Open) were 519 and 501, respectively, which were excellent.

Hereinabove, specific portions of the present disclosure have been described in detail, but it will be obvious to those skilled in the art that this detailed description is only a preferred embodiment and the scope of the present disclosure is not limited by this detailed description. Therefore, the substantial scope of the present disclosure will be defined by the accompanying claims and equivalents thereof.

What is claimed is:

1. A graphene coating composition for a wiper blade, comprising, based on a total weight of the graphene coating composition for a wiper blade:
1 wt % to 16 wt % of a solid lubricant;
80 wt % to 90 wt % of an organic solvent;
2 wt % to 8 wt % of a binder; and
0.5 wt % to 3 wt % of an additive,
wherein the solid lubricant contains graphene.

2. The graphene coating composition of claim 1, wherein the binder comprises polyurethane resin.

3. The graphene coating composition of claim 1, wherein the solid lubricant is contained in an amount of 6 wt % to 16 wt % based on the total weight of the graphene coating composition for a wiper blade.

4. The graphene coating composition of claim 1, wherein the graphene is contained in an amount of 10 wt % to 100 wt % based on a total weight of the solid lubricant.

5. The graphene coating composition of claim 1, wherein the solid lubricant further comprises one or more selected from graphite and boron nitride.

6. The graphene coating composition of claim 5, wherein the graphene is contained in an amount of 10 wt % to 90 wt % based on a total weight of the solid lubricant, and
the graphite is contained in an amount of 10 wt % to 90 wt % based on the total weight of the solid lubricant.

7. The graphene coating composition of claim 5, wherein the graphene is contained in an amount of 20 wt % to 80 wt % based on a total weight of the solid lubricant, and
the graphite is contained in an amount of 20 wt % to 80 wt % based on the total weight of the solid lubricant.

8. The graphene coating composition of claim 5, wherein the graphene is contained in an amount of 40 wt % to 85 wt % based on a total weight of the solid lubricant, and
the boron nitride is contained in an amount of 15 wt % to 60 wt % based on the total weight of the solid lubricant.

9. The graphene coating composition of claim 5, wherein the solid lubricant further comprises one or more selected from silicone powder, Teflon powder, PE powder, and a pigment.

10. The graphene coating composition of claim 9, wherein the graphene is contained in an amount of 70 wt % to 90 wt % based on a total weight of the solid lubricant,
the one or more selected from graphite and boron nitride are contained in an amount of 10 wt % to 30 wt % based on the total weight of the solid lubricant, and
the one or more selected from silicone powder, Teflon powder, PE powder, and a pigment are contained in an amount of 0 wt % to 1 wt % based on the total weight of the graphene coating composition for a wiper blade.

11. The graphene coating composition of claim 10, wherein the graphene is contained in an amount of 70 wt % to 90 wt % based on the total weight of the solid lubricant,
the graphite is contained in an amount of 10 wt % to 30 wt % based on the total weight of the solid lubricant, and
the Teflon powder is contained in an amount of 0.1 wt % to wt % based on the total weight of the graphene coating composition for a wiper blade.

12. The graphene coating composition of claim 10, wherein the pigment comprises a pearl pigment or an organic pigment.

13. The graphene coating composition of claim 10, wherein a particle size of the pigment is 9 μm to 40 μm.

14. The graphene coating composition of claim 1, wherein the graphene coating composition improves one or more of an abrasion resistance and a slip property of the wiper blade.

15. A wiper blade coated with the graphene coating composition for a wiper blade of claim 1.

16. A method for manufacturing a wiper blade, the method comprising coating the graphene coating composition for a wiper blade of claim 1 on a wiper blade.
